(19) United States
(12) Patent Application Publication
(10) Pub. No.: US 2020/0113203 A1
(43) Pub. Date: Apr. 16, 2020

(54) CHEWY CONFECTION COMPRISING PULSE STARCH AND METHODS OF MANUFACTURE THEREFOR

(71) Applicant: Puris Protein, LLC, Minneapolis, MN (US)

(72) Inventors: DAKOTA ROSE NOVAK, Forest Lake, MN (US); KUSHAL NARAYAN CHANDAK, St. Louis Park, MN (US); CASEY LYNN LOPEZ, Minneapolis, MN (US)

(21) Appl. No.: 16/600,305

(22) Filed: Oct. 11, 2019

Related U.S. Application Data
(60) Provisional application No. 62/745,221, filed on Oct. 12, 2018.

(51) Int. Cl. A23G 3/42; A23G 3/48; A23G 3/44; A23G 3/34

(52) U.S. Cl. CPC A23G 3/42; A23G 3/48; A23G 3/0051; A23G 3/001; A23G 3/44

(57) ABSTRACT

The present disclosure relates to a unique combination of pulse (i.e., non-soybean, non-peanut legumes) starch that creates chewy confections with consumer desired clean label, and the finished flavor and texture characteristics of traditional chewy confections. The chewy confection containing pulse starch and the process for manufacturing such, take advantage of the pulse starch high amylose content, while preventing processing challenges due to potential high viscosity development. The pulse starch in the chewy confection of this disclosure could be in isolated form (raw or at least partially precooked) or as part of other pulse materials. Preferably, the chewy confection of this disclosure meets FDA and non-GMO requirements, as well as being organic and kosher.

### CROSS-REFERENCE TO RELATED APPLICATIONS

The application claims the benefit of U.S. Provisional Patent Application No. 62/745,221, filed Oct. 12, 2018, entitled “Chewy Confection Comprising Pulse Starch and Methods of Its Manufacture”, which is hereby incorporated by reference in its entirety as if fully restated herein

### BACKGROUND OF THE DISCLOSURE

Chewy confections, such as jellies, gummies, or drops, are made by combining a gelling agent, water, and sugars, along with optional acid, flavors and colors. Because flavors and colors generally contribute nothing or very little to the bitefeel of the candy, this disclosure will focus on the ingredients that contribute to the bitefeel of the chewy confection. Nevertheless, flavors and colors are an important part of the confection and are taken into account outside of the bitefeel of the confection. Other ingredients such as pharmaceuticals, protein, fiber, minerals, vitamins, and nutraceuticals may be added, and may require adjustment of the formulation of the chewy confection without departing from the spirit of this disclosure.

The gelling agents used to make chewy confections are selected from the group consisting of agar, corn starch, gelatin, pectin, hydrocolloid, tapioca, other equivalent ingredients known in the confection arts, and combinations thereof. Although agar, pectin, gelatin, and hydrocolloid are well regarded for their bitefeel, corn starch is a highly popular ingredient because it is usually much less expensive than agar, gelatin, pectin or hydrocolloid. Some compositions use a combination of corn starch and pectin to strike a balance between cost and desirable bitefeel properties. Corn starch can be native or modified. Modifications can be chemical changes to corn starch to make the corn starch functionally different, such as creating a thinner viscosity (e.g., thin boil corn starch). These chemical modifications prevent such corn starches from meeting requirements to meet Verified Non-GMO Project and/or USDA Organic certification requirements. Modified corn starch can also be prohibited in confections' requirement for “clean label”. Native corn starch does not have sufficient functionality to create confections that have the desired textural characteristics, unless it is combined with other ingredients.

A highly popular chewy confection comprising agar called “gummy candies” (herein also called “jellies” and “gum drops”) is particularly desired in the marketplace for their bitefeel which combines high elasticity, high firmness, and high cohesiveness with low stickiness. Chewy confections comprising corn starch tend to be less elastic, less firm, less cohesive, and stickier than chewy confections made with different gelling agents, even if the corn starch is modified. Nevertheless, a broad range of texture types of chewy confections are popular in the marketplace.

Another highly popular chewy confection comprising a gelling agent, but are not usually as elastic as gummy candies, are also desired in the marketplace for their bitefeel. These confections (e.g., Sarburst C)) have a gelatin component to create a matrix (or gel) throughout the confection, and also has fine grain sugar crystals distributed throughout the matrix. As gelatin is expensive, and gelatin is also not allowed in Kosher products or vegetarian diets, another gelling agent would be preferred in these confections. Often modified corn starch is also used in these chewy confections, as partial or complete replacement of gelatin.

In a more diverse and health-conscious marketplace, consumers seek foods that do not contain genetically modified ingredients (non-GMO) and/or that comply with organic, kosher, or halal requirements. Generally, corn starch cannot comply with such requirements. While pectin can comply with such requirements, its expense renders it an impracticable ingredient to completely replace corn starch. Pectin also delivers a different end product texture than corn starch. This disclosure relates to an ingredient that can replace corn starch, agar gum, gelatin, pectin, and hydrocolloids in the manufacture of chewy confections, and still comply with consumer demand for non-GMO, organic, kosher, and/or halal compliant foods.

Manufacturers and consumers are looking for alternatives to corn starch and products traditionally made with corn starch. Preferably, the alternative is non-GMO, non-allergenic, organic, and complies with halal and kosher requirements. Even in confections, consumers seek alternatives that meet their nutritional and labeling needs. Chewy confections made by replacing corn starch with pea starch provides a familiar class of foods that fit with the foregoing market needs.

### Prior Art Compositions and Processes

For pectin to gel, acid and sugar are usually required. As a typical example, pectin is added to a 50/50 sugar/corn syrup solution, and cooked to a desired temperature. This is followed by the addition of an acid solution. However, sugar inversion may occur, so one must use a minimal amount of acid in the beginning, cook as rapidly as possible to the desired temperature, and then add additional acid to set the gel. The still fluid mixture is cast into a starch or plastic mold (i.e., molding) so that it will gel into a desired shape. The starch in the starch mold is usually (but not only) native corn starch with a small percentage of mineral oil, which allows the corn starch to hold a shape for molding. The corn starch in the mold can be used to pull moisture out of the work-in-process confection material. Pectin based confections are often poured into molds or onto “slab” pans or tables without use of corn starch.

Various chewy confections, such as gummies (also called jellies and gum drops) have been made commercially for years using corn starch (modified or native), pectin, gelatin, and/or gelatin. Candy Industry Catalog and Formula Book (Don Gussow Publications, Inc., New York, N.Y., 1950) contain many such formulas. For example; pectin jelly candy (flavor and color added as desired) can be made from sugar (100 lbs), corn syrup (100 lbs), pectin (2.5 lbs), acid (10 oz citric acid and 4.5 oz sodium acetate), and water (12 gals). The corn syrup, sugar, pectin, and water are heated to 226° F. or more in less than 30 minutes—preferably not over 18-20 minutes. Any acid not used to solubilize the pectin should be added to the final deposit and heated for than 20 minutes—preferably 6-10 minutes—so that the mixture has evaporated into proper ratios of components for gel formation (accounting for carbohydrate hydrolysis and inversion). Proper buffer control is needed to make the pH low enough to avoid browning and pectin degradation, yet high enough to minimize invert sugar formation.(Candy Industry, 1950)

As another example, pectin jelly candy is made by: 1) heating 12 gal water to about 140° F. over 22 minutes, and adding 20 lb sugar, 2.5 lb pectin, 4.5 oz NaOAc, and 2 oz citric acid (the mixture should have a pH of about 4.28); 2) the mixture is then heated to a vigorous boil followed by the successive addition of 80 lb sugar and 100 lb corn syrup; 3) the mixture is cooked rapidly to 227 ° F. followed by the addition, over 8 min and bringing the pH to 3.49, of 8 oz citric acid in water; and 4) deposit on to a slab or into a mold to form the desired shape. (Candy Industry, 1950)

As a further example, cast fruit jelly is made by: 1) dry mixing 1 lb modified pectin with some sugar and stirring the mixture into 2.5 gal water and boiling until the solids are dissolved; 2) adding 2 oz buffer in 4-5 oz water and bringing mixture back to boil; 3) adding the rest of 25 lbs sugar and 35 lbs corn syrup; 4) boiling to 266° F.; 5) turning off the steam, then adding flavor and color followed by 2 oz 50% acid solution; and 6) casting in starch. (Candy Industry, 1950)

Thin boil corn starch (modified corn starch) is often used to cast starch jellies, gums, or drops. The right amount of corn starch is needed for jelly (11-12%). Too much corn starch may render the jelly too tough. Too little corn starch may cause the jelly to fall apart too easily. In the case of corn starch, adding too much acid when cooking will break down the starch and may also cause it to fall part too easily.

As used herein, the term gum does not refer to chewing gum made from natural or synthetic rubbers. Herein, gum refers to chewy candy that can be swallowed and will dissolve when consumed. As an example, a gum drop is made by: 1) bringing to a fast boil 600 lb corn syrup, 50 gal water, and 6 oz tartaric acid; 2) slowly adding 72 lbs corn starch suspended in 22 gal water so that the batch stays boiling at all times until a palette knife test shows heavy strings; and 3) adding desired color and flavor and casting into starch. Fast boil starch should cook in 30-40 minutes, while slow boil starch cooks in 90 minutes. (Candy Industry, 1950)

As another example, orange slice jellies are made by: 1) bringing 60 lb corn syrup and 8 gal water to boil; 2) adding 14 lb corn starch suspended in 6 gal water slow enough to keep the batch boiling; 3) adding 60 lb sugar, 2.5 oz cream of tartar; 4) cooking fast until a palette knife test shows light strings; 5) at the desired solids concentration, adding 1 oz tartaric acid in 1 oz water; 6) then adding color and flavor (e.g. 3 oz orange oil); and 7) casting into dry starch. (Candy Industry, 1950)

### Texture

Many terms can be used to describe the sensorial properties of chewy confections. In this specification and claims, the term firm texture means that there is resistance when the chewy confection is first bitten into. An elastic texture herein means the chewy confection has a spring-back elasticity, when chewed. A cohesive texture herein means that when the chewy confection is chewed, the product mass feels like it is holding together and not dissolving or disintegrating fast as it is chewed. Stickiness herein describes the composition's tendency to adhere to solid surfaces that come in contact with the composition. For example, many chewy confections tend to adhere to teeth as it is chewed. While this is sometimes a desired property, it is undesirable for many confections. Stickiness can also be tested by pressing on the composition with a finger to determine if the composition will adhere to the finger.

A texture can be created such that it could be described as firm (i.e., there is resistance when first bitten into), elastic (i.e., has a spring, or give when bitten into and chewed), cohesive (i.e., feels like it is holding together when chewed, or is not dissolving fast when chewed), and not sticky (will not stick to teeth or the roof of the mouth). A preferred embodiment of chewy confection texture of the present disclosure should be firm, elastic, cohesive, and not highly sticky.

The developers of the embodiments of the current disclosure found that the percentage of pulse (preferably pea, chickpea, and combinations thereof as described below) sourced starches can be shifted to create a range of different textures desired by consumers. The developers of the embodiments of the current disclosure found that certain ratios of pulse based ingredients created chewy confections with better shelf-life because they are stable against absorption of water from the environment in which they are stored.

### Pulse

Pulses are non-soybean, non-peanut legumes, including, but not limited to, peas, beans, lentils, and chickpeas. As used herein, “pea” means the mostly small spherical seed of the pod fruit Pisum sativum. In a preferred embodiment, the pea used in this disclosure are varieties of the species typically called field peas, yellow peas, or wrinkled peas that are grown to produce dry peas that are shelled from the mature pod. Peas have been bred to manifest numerous phenotypic characteristics. These breeding practices, as well as the cultural eating histories of so many people, make peas an excellent food source for many consumers world-wide. Another advantage of using pulse ingredients is that peas and other pulses generally are not allergens, do not cause digestive problems, and have little, if any, objectionable flavor. Fiber, preferably from pulse, can be added to candy to keep it moist which allows it to stay chewy and can prevent the sugars from crystalizing. Addition of dietary fiber into a chewy confections is an excellent means of getting more dietary fiber into the American consumer diet.

Preferably, the pulses used to produce the chewy confections of this disclosure are non-GMO according to industry certified non-GMO standards (e.g. Verified Non-GMO Project) and by FDA regulations. Non-GMO means not genetically modified. The FDA.gov website currently includes guidance for manufacturers who wish to voluntarily label food as containing or not-containing genetically modified ingredients. Additional label regulations as to mandatory labeling or foods containing genetically modified ingredients are being developed for enforcement starting roughly the year 2020. Under these regulations, traditional breeding of pulse plants would not be considered genetic modification. Preferably, the pulses used to produce the chewy confections of this disclosure are produced by traditional breeding methods and not by genetic modification.

Preferably, the pulses used to produce the chewy confections of the disclosure are Organic Certified according to USDA regulations. Organic Certified means that the source of the ingredients and the finished food product have been produced according to specific requirements such that pulses would only come in contact with USDA organically approved herbicides, pesticides, process aids, and cleaning materials.

### Pulse Starch

Pulse starch (especially pea starch) contains a uniquely high amylose content, which allows this starch to be surprisingly helpful in creating chewy confections with ideal and preferred texture. In theory, the amylose molecular chains of glucose (that is at a uniquely high content level in pea and chickpea starch) can align and create a network with each other to create a matrix, also called a gel. The matrix structure can encompass the entire confection mass and can trap molecules such as water and other ingredients under proper processing conditions. Another component of pulse starch is amylopectin. In theory, the amylopectin chains of glucose are highly branched and can bond and trap water molecules within its structure. While the amylopectin can absorb water within its branched structure, amylose connects those hydrate branched molecules together into a matrix that can extend across the entire confection mass. Other ingredients can strengthen or weaken the matrix, including acid that can break some glucose to glucose bonds in the starch. In chewy confections, by this theory the pulse starch (especially pea starch) structure could aid in making the resulting chewy confections stronger and more resistant to chewing (i.e., firmer bite, more elasticity, greater cohesion, and less sticky).

This disclosure relates to the use of pulse starch that can replace corn starch in the manufacture of chewy confections, while complying with consumer demand for clean label, non-GMO, organic, kosher, and/or halal compliant foods. Preferably, the pulse starch is a pea starch. Products having a clean label are those that comply with the standards and regulations to be non-GMO, organic, or kosher and/or halal requirements, as well as containing no ingredients that appear to be chemicals or “modifications”. By using pea starch, one can meet the demands of a chewy confection having a clean label, including being non-GMO, organic, and halal.

Pea starch is also not an allergen identified by FDA, which are wheat (gluten), eggs, soybeans, peanuts, milk, tree nuts, and crustacean shellfish. Gelatin, usually made from pork, does not meet kosher or halal dietary regulations.

### SUMMARY OF THE DISCLOSURE

The present disclosure relates to a unique combination of pulse (i.e., non-soybean, non-peanut legumes) starch that creates chewy confections with consumer desired clean label, and the finished flavor and texture characteristics of traditional chewy confections. The chewy confection containing pulse starch and the process for manufacturing such, take advantage of the pulse starch high amylose content, while preventing processing challenges due to potential high viscosity development. The pulse starch in the chewy confection of this disclosure could be in isolated form (raw or at least partially precooked) or as part of other pulse materials. Preferably, the chewy confection of this disclosure meets FDA and non-GMO requirements, as well as being organic and kosher.

### DETAILED DESCRIPTION OF THE DISCLOSURE

The present disclosure is directed to a chewy confection comprising pulse ingredients having a clean label (including simple ingredients, non-GMO, USDA organic, kosher, and/or halal) and finished confection product flavor, and texture characteristics. In particular, the chewy confection embodiment of this disclosure has the flavor and texture expected of chewy confections without the need for corn starch (modified or not modified), gelatin, pectin or hydrocolloids.

The process of this disclosure is a method of manufacturing the chewy confection embodiments of this disclosure with the flavor and textural characteristics desired by consumers, while meeting labeling and dietary needs. The process for making the chewy confection of the current disclosure is not limited by the equipment used to make the chewy confection. The process embodiments of the current disclosure includes a means of overcoming the high viscosity functionality pulse starch material. This means includes longer cook time at 190-200 F and/or addition of food grade acid (e.g., citric acid) before or during this extended cook.

The pulse starch used in the chewy confection of embodiments of this disclosure can be isolated from pea flour (made by wet milling or dry milling peas) and be in a raw state, or can be further processed into a precooked state. The further processing can be accomplished by various means, preferably by such means that includes heating at least some (but not all) of the starch granules to above their gelatinization temperature. This treatment gives the starch more functionality, such as more gelling and more thickening capabilities. In theory, this greater functionality, combined with the high amylose content of pea starch, creates a unique functionality that allows the creation of the pulse based chewy confection of the current disclosure.

The pulse starch used in the chewy confection embodiments of this disclosure can also be from the pulse material naturally, that is, as in its natural form in the pulse seed. The pulse starch can be in its raw state in a pulse flour, which is a dry or wet milled ground seed material. The pulse starch or pulse flour can also be in a precooked state, wherein at least part, but not all, of the starch granules are partially gelatinized. To make such a precooked the pulse seed is wet or dry milled, and then heated to a temperature above the gelatinization temperature of the pulse starch. To make a precooked pulse starch, the pulse seed is wet or dry milled, the starch is removed from the pulse flour, and the pulse starch is then heated to a temperature above the gelatinization temperature of the pulse starch. This wet heat treatment gives the starch more functionality, such as more gelling and more thickening capabilities. In theory, this greater functionality, especially if the pulse is pea (which has a high amylose content), creates a unique functionality that allows the creation of the pulse based chewy confection embodiments of the current disclosure.

When the finished chewy confection is ideally clear, then preferably relatively pure pulse starch would be used with soluble ingredients (including but not limited to soluble dietary fiber, flavors, nutraceuticals, vitamins, minerals) in making the chewy candy (e.g., jellies, gum drops, gummies). When the finished chewy confection is to be opaque, such as in chewy confections with crystallized sugar, then less pure versions of the starch, as well as less soluble ingredients (including but not limited to insoluble fiber, spices, minerals, coco powder, particulates) can be used in making the chewy confections.

### EXAMPLES

Native pulse starch does not have the same composition as corn starch (modified and native) and as such creates process challenges when using formulas and processes designed for corn starch. Native pulse starch is an intact granule that requires significant cooking (heat) and shear to completely cook out (i.e., loosen structure and hydrate glucose chains). When pulse starch does cook out, it has a significant viscosity, which could cause challenges in conveying the material to and through depositing. In one embodiment of the current disclosure, a method of manufacture (i.e., process) reduces the need to process pulse starch (preferably pea starch) under more extreme conditions of heat and shear by adding acid early in the process to weaken the alpha 1,4 bonds in the starch to facilitate a faster, more complete cookout and a lower end hot viscosity. This process yields a chewy confection slurry that is thinner while hot yet sets back to a more ridged gel. Moreover, this process creates less viscus pre-gel that does not gel too quickly on the outside surface to form a skin that traps moisture inside the skin and creating a sticky inner mixture under the skin. The less viscous pre-gel sets more evenly creating a more uniform textured chewy confection and a longer shelf-life (due to less, or at least predictable) moisture movement post process.

Due to the high amylose starch content, pulse starch (especially pea starch) forms a good gel relative to other plant starches (such as corn starch). The long, unbranched amylose starch molecules create a matrix structure under ideal water content and heat content conditions. As the gel dries, the gel can become less flexible unless other ingredients are added to the gel dough. But the addition of pule fiber (especially pea fiber) could extend the time that the gel could remain flexible, as well as making the gel more flexible and durable to tension. The fiber would hold water within the gel, with the water allowing the molecules within the gel to move fluidly around each other. The fiber could also form its own matrix within and throughout the pulse starch gel matrix. Other lubricators old also be added to the gel composition. Lubricators, such as glycerin and sugar alcohols, could add to the flexibility of the gel by being hygroscopic agents which maintain moisture within the gel.

If a more firm textured confection was desired, then a fine sugar crystal structure could be developed within the pulse starch matrix by incorporating fine crystalline sugar to nucleate sugar crystal growth under the controlled water environment of a pulse starch based gel chewy confection. Addition of pulse fiber to the chewy confection could aid in the control of sugar crystal growth by managing the water content and/or by restricting growth through physical interference.

Various chewy confection examples were produced on pilot plant equipment at the University of Wisconsin—Madison. Initial formula and process were supplied by U of W from their candy education classes. These process methods and formulas were a starting point, though U of W technicians thought that pea starch would create a too viscous hot confection mass for depositing.

The inventors of the chewy candy embodiments of this disclosure found this to be true under the starting formula and process. The inventors found process conditions and formula changes that allowed the creation of pulse starch based chewy confections that had the desired flavor and texture characteristics.

In embodiments of the current disclosure, food grade acid (example, but not limited to citric acid) is added in the first phase of cooking pulse starch to create a slurry, and then the slurry is processed through a jet cooker to break down the starch into smaller chains that, after processing, releases moisture more readily and allows the product to set in good time to a nice rigid gel. This process yields a gummy slurry that is thinner while hot yet sets back to a more ridged gel. The gummy slurry deposits readily and has no tailing compared to other gummy slurries that are more viscous.

Chewy Confection Examples

In Table 1, includes processing details and comments on a series of gummy (i.e., chewy confections) examples made in pilot plant sized equipment and then stored in closed plastic bags at ambient room temperature (about 72 F) and ambient relative humidity. Examples were evaluated for sensorial characteristics at roughly 5 days and 48 days

TABLE 1
Gummy Trial Example Formulations

| | Ingredient % | | | | | |
|---|---|---|---|---|---|---|
| | | | 50% Acid | | | 100% Pea |
| | | | Thinned | 75% Pea/25% | | with 50% of |
| | | 100% Pea | Starch/50% | thin boiled | 69% Pea/ | acid added |
| | | Starch | Pea Starch | corn starch | 31% tapioca | early |
| Example | Control | (2) | (8) | (1) | (3) | (4) |
| 62 DE corn syrup | 48.98 | 48.98 | 48.98 | 48.98 | 48.98 | 48.98 |
| Sugar | 32.58 | 32.59 | 32.58 | 32.58 | 32.58 | 32.59 |
| Water | 8 | 8 | 8 | 8 | 8 | 8 |
| Thin Boiling Corn | 6.6 | 0 | 4.78 | 2.97 | 0 | 0 |
| Starch | | | | | | |
| (Confectioners G) | | | | | | |
| High Amylose Starch | 2.97 | 0 | 0 | 0 | 0 | 0 |
| (Hi-set C) | | | | | | |
| Pea Starch | 0 | 9.57 | 4.78 | 6.6 | 6.6 | 9.57 |
| Tapioca Starch | 0 | 0 | 0 | 0 | 2.97 | 0 |
| Color | 0.07 | 0.07 | 0.07 | 0.07 | 0.07 | 0.07 |
| Flavor | 0.07 | 0.07 | 0.07 | 0.07 | 0.07 | 0.07 |
| Citric Acid | 0.73 | 0.73 | 0.73 | 0.73 | 0.73 | 0.73 |

Gummy Trial Examples continued

| | Ingredient % | | |
|---|---|---|---|
| | Pea Starch/ | Pea Starch/ | 100% |
| | Pectin | Pectin | Pre-gel |
| | 50% Reduction | 75% Reduction | Starch |
| Example | (5) | (6) | (7) |
| 62 DE corn syrup | 36.2 | 36.16 | 48.98 |
| Sugar | 28.06 | 28.12 | 32.59 |
| Water | 28.8 | 28.91 | 8 |
| Thin Boiling Corn | 0 | 0 | 0 |
| Starch | | | |
| (Confectioners G) | | | |
| High Amylose | 0 | 0 | 0 |
| Starch (Hi-set C) | | | |
| Pea Starch | 4.6 | 4.54 | 9.57 |
| Tapioca Starch | 0 | 0 | 0 |
| High methoxyl | 0.5 | 0.38 | 0 |
| pectin | | | |
| 50% Citric Acid | 1.7 | 1.75 | 0.73 |
| soln. | | | |
| Color | 0.07 | 0.07 | 0.07 |
| Flavor | 0.07 | 0.07 | 0.07 |

TABLE 2
Process Details and Production Comments

| Example | Process | Notes | Next Steps |
|---|---|---|---|
| 1) 75% Pea starch, | 1) Cook in GROEN | Good viscosity, | Increase Brix with |
| 25% Thin boiled corn | steam jacketed kettle | similar to that of | higher solids in first |
| starch | to 200° F. (to 82 Brix) | Control. | cook. Add acid |
| | 2) Jet cook (301° F. @ | Nice and clear | before first cook. |
| | 16 RPM), Adds water | (translucent) out of | |
| | (80 Brix). Acid added | kettle and out of jet | |
| | at end. | cooker. Not very | |
| | | sticky; Nice | |
| | | depositing (not too | |
| | | viscous and no | |
| | | tailing). | |
| 2) 100% Pea starch; | 1) Cook in GROEN | Viscosity very thick | Increase Brix with |
| acid added after jet | steam jacketed kettle | up to 160° F. then | higher solids in first |
| cooker (i.e., late) | to 200° F. for 5 min (to | thins about 165° F., but | cook. |
| | 80 Brix) | still more viscous | |
| | 2) Jet cook (300° F. @ | than Control after jet | |
| | 16 RPM), Adds water | cooker. Nice and | |
| | (78 Brix) | clear out of jet cook | |
| | | Thicker than Control, | |
| | | more difficult to | |
| | | deposit. Tailed. | |
| | | Very nice flavor | |
| 3) 69% Pea starch, | 1) Cook in GROEN | Thickened up to | Increase Brix with |
| 31% Native tapioca | steam jacketed kettle | 160° F. then thinned at | higher solids in first |
| starch | to 200° F. for 5 min. (to | about 165° F. | cook. Add acid |
| | Brix 80). | Very clear off jet | before first cook. |
| | 2) Jet cook (300° F. @ | cooker. | Replace more of the |
| | 16 RPM). Adds water | Thicker than Control | tapioca starch with |
| | (77 Brix) | so harder to deposit | pea starch. |
| | | than Control. Some | |
| | | tailing. Tasted | |
| | | starchy. | |
| 4)100% Pea starch | 1) Cook in GROEN | Thinner after jet | Increase Brix with |
| with 50% citric acid | steam jacketed kettle | cooker than 100% | higher solids in first |
| soln (at 50% | to 200° F. for 5 | pea starch and 75% | cook. |
| concentration) added | min. (82 Brix) | pea/25% tapioca | |
| to reach pH 2 before | 2) Jet cook (300° F. @ | starch. | |
| 200 F. cook started. | 16 RPM). Adds water | Deposited like | |
| | (80 Brix) | Control. | |
| | | Sweet flavor with | |
| | | less citric bite than | |
| | | other 100% pea | |
| | | starch sample. Very | |
| | | bright flavor like | |
| | | 75% pea starch/25% | |
| | | tapioca starch. | |
| 5) Pea starch, 50% | 1) Cook in GROEN | Very good cook up | Increase Brix with |
| reduction in pectin | steam jacketed kettle | with viscosity similar | higher solids in first |
| | to 200° F. for 5 min. | to Control. Deposited | cook. Replace more |
| | (to 82 Brix). Acid | acceptably in starch | of the pectin with pea |
| | added after cook. | molds. Poured on | starch. |
| | 2) No Jet cook | cooling table without | |
| | | molding starch, made | |
| | | semi-firm slab. | |
| 6) Pea starch, 75% | 1) Cook in GROEN | Very good cook up | Increase Brix with |
| reduction in pectin | steam jacketed kettle | with viscosity similar | higher solids in first |
| | to 200° F. for 5 min (to | to Control. Deposited | cook. Replace more |
| | 82 Brix) Acid added | acceptably in starch | of the pectin with pea |
| | after cook. | molds. Poured on | starch. |
| | 2) No Jet cook | cooling table without | |
| | | molding starch, made | |
| | | semi-firm slab. | |
| 7) 100% Pre-gel pea | 1) Cook in GROEN | Different cook up | Add more shear |
| starch (50 mesh | steam jacketed kettle | results: at 80° F. thick; | before cooking. Try |
| particle size) | to 200° F. for 5 min (to | at 103° F. thinning; at | adding acid before |
| | 82 Brix). Acid added | 160° F. become clear; | cooking. |
| | after cook. | but not total clear; | |
| | 2) No Jet cook | and at 200° F. nice and | |
| | | low viscosity. | |
| | | Appeared more | |
| | | opaque with some | |
| | | clumping at | |
| | | depositing (not all | |
| | | starch dissolved, | |
| | | hydrated, and/or | |
| | | cooked); Deposited | |
| | | nicely (i.e., okay | |
| | | viscosity and no | |
| | | tailing). Molded | |
| | | examples did not set | |
| | | well. Slab did not | |
| | | firm up. | |

Control Process: (Same as Two Step Cook, except for Control did not have 5 in hold at 190-200 F)

1) Ingredients were weighed according to the following information; 2) Dry ingredients were pre-blended; 3) Water and corn syrup were heated in steam jacketed kettle before adding dry ingredients; 4) Mixture was heated to 200 F and a certain Brix; 5) Mixture was transferred to jet cooker which was then heated to 301F at 16 RPM and to a final Brix; 6) Jet cooked material was placed in a bowl, where flavor, color, and citric acid was added; 7) Material was deposited in corn starch molds; and 8) Deposited material was allowed to cure 130 F and 0% humidity. Brix was between 75 and 85.

Below are the more detailed description of the example's processes referenced to in Table 2.

Detailed Chewy Confection Process: One Step Cook:

1) Ingredients were weighed according to the following information; 2) Dry ingredients were pre-blended; 3) Water and corn syrup were heated in steam jacketed kettle (Groen kettle) before adding dry ingredients; 4) Mixture was heated to 190-200 F and held at that temperature for a time of 0 to 5 min and to a certain Brix; 5) Cooked material was mixed with flavor, color, and citric acid; 6) Material was deposited in corn starch molds; and 7) Deposited material was allowed to cure 130 F and 0% humidity. Pectin containing confection material was also poured onto a cure slab or pan without molding starch.

Detailed Chewy Confection Process: Two Step Cook

1) Ingredients were weighed according to the following information; 2) Dry ingredients were pre-blended; 3) Water and corn syrup were heated in steam jacketed kettle (Groen kettle) before adding dry ingredients; 4) Mixture was heated to 190-200 F and held at that temperature for a time of 0 to 5 min and to a certain Brix; 5) Mixture was transferred to jet cooker which was then heated to 300-301F at 16 RPM and to a final Brix; 6) Jet cooked material was placed in a bowl, where flavor, color, and citric acid was added; 7) Material was deposited in corn starch molds; and 8) Deposited material was allowed to cure 130 F and 0% humidity.

For 100% pea starch example (4) where a portion of the acid was added early, step 3) of the Two Sep Cook includes acid addition (and pH of 1-3 obtained) before step 4 heating to 190-200 F.

A process goal of the first cook in the Groen steam jacked kettle was to reduce the water content (thus increasing Brix) and hydrate the amylopectin and the amylose molecules. With a two step cook process, that heated mass was then put through the jet cooker, which gave a higher temperature cook than the Greun Kettle (open kettle). This improved the hydration of the starch molecules while creating conditions for matrix formation as example formulas cooled. Unfortunately, jet cooking adds water into a cooked mass from the steam condensation.

Added time appeared to be necessary for pea starch, over that needed for corn starch. The pea starch molecules needed more time at 200 F to be optimally prepped to absorb water and create a strong gel, but the prep had to be done without detrimentally damaging the amylose (or amylopectin) structure. The inventors found that increasing the time of open kettle cook (Groen) from 5-10 minutes at 190-210 F worked for pea starch.

A goal of the inventors of this disclosure was to reduce the viscosity of the pea starch (but not reduced too far) so that it would flow better through the jet cooker and through the depositor and deposit well (e.g., including but not limited to depositing with no tailing or drips or too slow a flow rate through the depositor). One reason tailing occurs because the material being deposited has too long a texture and as such is difficult to “cut off” the amount flowing from a depositor head. A longer texture can be caused on longer molecular chains. Tailing also occurs if the material being deposited is sticky and sticks to the depositor and thus builds up mass until gravity causes it to fall on the starch mold tray below it. Tailing can also occur if the material being deposited is too thin, and leaks from the depositor on to the starch mold tray. Hence, a material being deposited nicely (for example, but not limited to, without tailing or dripping) cannot be too thick (i.e., viscous) or too thin. Also, in automatic depositors with synchronized starch trays, too viscous a material would also cause difficulties in getting the material to fill the depositor head and then fall to the tray at an even pace that can match the movement of the depositor head and tray with molds. Too viscous a material could have difficulties completely filling all of the crooks and crannies of the mold shape in the starch tray.

Acid is usually added to chewy confections for flavor, especially with citrus flavored confections. The inventors of this disclosure decided to use that acid to create an improved depositing chewy confection material with the surprising results of not damaging the flavor or the texture of the final chewy confection. The addition of the acid before the first cook, along with the longer cook before the jet cooker created a chewy confection material with the right viscosity and shortness of texture that it flowed well in the jet cooker and the depositor, as well as filled the molds well with no shape defects—as well as having an acceptable texture (compared to Control).

Table 1 comprises a range of formulas containing no pea starch (Control) to containing only pea starch. This range of formulas also comprises combinations of pea starch with other starches (including thin boiling corn starch, tapioca starch) and other non-starch gelling agents (pectin). Though the finished product pectin containing samples were softer than the Control, that was not necessarily a detriment to the finished products. Pectin based chewy confections are often softer than chewy confections based on starch or gelatin. The combinations tested in these examples showed that pea starch can be used with other gelling agents to create finished products with a wide range of end textures, while not being too viscous to be easily deposited into starch molds or slab table cooled. Note that the pectin and pea starch examples did not have a jet cook (which would have damaged the gelling ability of the pectin) and jet had acceptable viscosity and matrix building capacity.

Sensorial Evaluation of the chewy confection examples with the formulas in Table 1 made with the processes in and after Table 2 were evaluated at about 5 days and 48 days after production.

Appearance: All of the trial examples had translucent appearances, which is the ideal for gummies (also called jellies and gum drops) type of chewy confection. Example 7 had some opacity, most likely due to incomplete hydration during its one step cook process.

TABLE 3
Taste and Bitefeel: Evaluation at 5 Days

| Example | Taste | Bitefeel |
|---|---|---|
| Control | More sweet than orange | Not slimy, chewier, a bit sticky, soft |
| 100% pea starch, acid | Bright orange flavor, no “off” | Not as soft as control, not slimy, |
| added late | flavor | chewy, more elastic, sticky |
| 100% pea starch, | Bright orange flavor, no “off” | Slightly firmer than 100% pea |
| some acid added | flavor | starch, acid added late, but slightly |
| early | | less firm than 50/50 pea/corn starch |
| | | and 75/25 pea/corn starch; chewy, |
| | | high elasticity |
| 50/50 pea starch/thin | Dull orange flavor | Firmer than 100% pea starch and |
| boiled corn starch | | control; less sticky than 100% pea |
| | | starch and control |
| 75/25 pea starch/thin | brighter orange flavor than | Chewier and firmer than 100% pea |
| boiled corn starch | 50/50 example but duller than | starch and control; same stickiness |
| | 100% pea | as 50/50 example |
| 75/25 pea starch/ | Snotty, high tapioca flavor, | Very soft and stringy, no clear bite, |
| tapioca starch | more sweet than orange like | mushes easily |
| | control | |

As illustrated in Table 3, the net result of the sensorial evaluation of these very fresh examples was that they had some differences from each other, but were all very soft. Not all examples were available for evaluation at 5 days, as many were sticky and lumped together during transportation from the production site. See Table 2 for process comments on all examples made.

As those with experience in the candy arts knows, chewy confections change in texture as they age (i.e., cure), even once they are out of their corn starch molds. The matrix molecules pull tighter to each other, moving trapped water out of their structures. The branched molecules both align tighter with their neighbors (i.e., retrogradation), also moving water out of their structures. All of the molecule to molecule interactions shift as they try to reach an equilibrium, especially this is true between water and molecules both inside the chewy confection and in the atmosphere around the confections. For this reason, it is very important to create chewy confection material that can lose its excess water quickly before it gets trapped inside the chewy confection's packaging. Too much available water within a chewy confection mass can raise the product's water activity to the point where mold and yeast can grow. If too much water is moved to the surface in a closed package (so it cannot leave the product's surface), then that excess water could raise the water activity of the confection surface high enough for mold or yeast to grow. So the inventors of the chewy confection embodiments of the current disclosure had to include formula and process contents and conditions that would allow the water to more quickly move from the center of the confection mass in a mold to the atmosphere. Pea starch can create a film on the outer surface of deposited chewy confection masses, which can create barriers to the movement of water out of the deposited mass. The addition of acid before or during the first cook and the lengthening of the first cook not only created a less viscous mass to aid depositing, but also created a shorter texture and more “breathable” texture that reduces the tendency to create surface film or other forms of barrier to water movement out of the chewy confection.

TABLE 4
Gummy Example Evaluations: Sensorial Evaluation at 48 days: (All not
sanded with sanding sugar versus all sanded with sanding sugar

| Example | Firmness | Stickiness |
|---|---|---|
| 75% pea/ | Slightly softer than | Not sugared was similar |
| 25% thin | Control both when | stickiness not sugared Control; |
| corn | sugared and when | Not sugared was less sticky |
| starch (1) | not sugared | than sugared examples |
| Corn Starch | Unsugared Control was | Unsugared Control was less |
| Control | softer than sugared | sticky than sugared Control |
| | Control | |
| 50% pea/ | Slightly softer than | Not sugared was similar |
| 50% thin | Control both when | stickiness not sugared Control; |
| corn | sugared and when | Not sugared was less sticky |
| starch (8) | not sugared | than sugared examples |

Table 4 shows that at 48 days, sanding the chewy confection pieces with sugar crystals made all of the samples seem firmer and masked some of the differences between formulas that was present when processed and when evaluated at 5 days (unsanded). There was not a significant difference between the texture of examples with 75/25 or 50/50 pea starch/acid thinning corn starch.

In Table 5, gummy examples made and store for 48 days and then evaluated for firmness and stickiness after sanding (application of granular sugar on the surface) and compared with commercial products: Nice Brand (Walgreens) Sanded Fruit Slices purchased 10/7/2018 with best used by date of 11/23/2019 and Nice Brand (Walgreens) Sanded Gum Drops purchased 10/7/2018 with best used by date 07/06/2019. It should be noted that the commercial fruit slices, which was made with only modified corn starch, was softer and stickier than the commercial gum drops, which was made with both modified corn starch and corn starch.

Differences between the unsanded control and the unsanded versions of both 100% pea starch products were more pronounced than the sanded products. It is apparent that sanding masks some of the softness and stickiness of the chewy confections.

TABLE 5
Gummy Example Evaluations Compared to Commercial Products

| Example | Firmness | Stickiness |
|---|---|---|
| Unsanded, | Much softer than | Much stickier than commercial |
| starch dusted | commercial products. | products |
| Corn Starch | | |
| Control (A) | | |
| Sanded Corn | Much softer than | Much stickier than commercial |
| Starch | commercial products. | products |
| Control (B) | | |
| Sanded 100% | Slightly softer than | Slightly stickier than the sanded |
| pea starch (C) | the sanded control B | control B |
| Sanded 100% | Slightly softer than | Slightly stickier than the 100% |
| pea starch | the 100% pea C | pea C |
| processed with | | |
| early acid (D) | | |

In Table 6, gummy examples made and stored for 48 days and then evaluated for firmness and stickiness by squeezing in comparison with control. Control and pea starch containing products had the same firmness to squeezing between the fingers.

TABLE 6
Gummy Example Evaluations

| Example | Firmness | Stickiness |
|---|---|---|
| A from Table 2 | | |
| B from Table 2 | | |
| Unsanded, starch | Slightly softer than G,. | |
| dusted 75% pea | | |
| starch/25% tapioca | | |
| starch (E) | | |
| G from Table 1 | Slightly softer than A | Similar |
| | | stickiness to A |
| Sanded 50% pea | Slightly firmer than B | Slightly |
| starch/50% corn | | stickier than B |
| starch (F) | | |

Texture analysis was performed the resulting gummies by compression. As seen on Table 7, all of the pea starch formulations were firmer than the control. This is not an undesirable result since such firmness is known and desired for agar-based gummies.

TABLE 7
Texture Analysis by Compression: Average Sample Hardness

| | |
|---|---|
| Example | Force (grams) |

| | |
|---|---|
| Control | 2386 |
| 100% pea starch, acid | 3532 |
| added late | |
| 100% pea starch, | 3300 |
| some acid added | |
| early | |
| 75/25 pea starch/thin | 3500 |
| boiled corn starch | |

Texture analysis was done using a Texture Analyzer at the University of Minnesota, Food Science Department. The Average force applied was measured in grams of pressure to compress set amount and size of samples of the examples at roughly 5 days of ambient storage after production.

TABLE 8
Sample Average Hardness

| | Average Force | Average Force |
|---|---|---|
| | (g) TA.XT2 | (g) |
| PURIS control in | 3995.191 | 3995.191 |
| sugar | | |
| PURIS control | 2386.432 | 2845.094 |
| 100% pea starch | 3532.715 | 2065.075 |
| pea acid 2 pH | 3313.067 | 3313.067 |
| 50% pectin | 2506.661 | 2506.661 |
| reduction | | |
| 75% pea 25% acid | 3511.976 | 2579.245 |
| 75% pea 25% | 4387.049 | 5160.348 |
| tapioca | | |
| 50% pea 50% acid | 6230.474 | 6230.474 |
| thinned | | |

Texture analysis was done using a Texture Analyzer at the University of Minnesota, Food Science Department. The Average force applied was measured in grams of pressure to compress set amount and size of samples of the examples at roughly 5 days of ambient storage after production. These formulas refer to the formulas in Table 1, with thin referring to acid thinning corn starch; sugar referring to example chewy confection pieces sanded with sugar; acid 2 pH referring to example #4; and pectin reduction referring to example #5. The TA results illustrate several interesting aspects of the examples. For example, the sugar sanding of the 50% pea starch/50% acid thinned corn starch example created a less hard result than unsanded. As sugar sanding can lead to an over firming of the sample because of the hardness of a sugar sand coating, it is interesting that the sugar sanding actually created a less hard result—possibly due to the sugar coating keeping water from leaving the chewy confection piece (so maintaining a wetter softer center, in spite of the harder surface). But—the sanded Control example was harder than the unsanded Control sample, which is reverse the trend found with the 50%/50% sanded/unsanded example results. The differences between these sets of hardness texture analyzer data could be due to the functions of the starches within the examples.

Also, the 75% pea starch/25% tapioca starch example (unsanded) result was harder than that of the 75% pea starch/25% acid thinning corn starch (unsanded)—and both were harder than the unsanded control. The sanded Control example was harder than the unsanded Control sample, which is reverse the trend found with the 50%/50% sanded/unsanded example results.

The compositions and methods of the present disclosure are capable of being incorporated in the form of a variety of embodiments, only a few of which have been illustrated and described. The disclosure may be embodied in other forms without departing from its spirit or essential characteristics. The described embodiments are to be considered in all respects only as illustrative and not restrictive, and the scope of the disclosure, therefore, is indicated by the appended claims rather than by the foregoing description. All changes which come within the meaning and range of equivalency of the claims are to be embraced within their scope.

We claim:

1. A chewy confection comprising: a) pulse starch; b) sugar; c) water; and d) acid, as well as additional ingredients including but not limited to colors, sensients, flavors, fruit based ingredients, high intensity sweeteners, sugars, sugar alcohols, dextrin, maltodextrins, oils, fats, inclusions, or combinations thereof.

2. The chewy confection of claim 1, wherein the pulse starch is pea starch, chickpea starch, or combinations thereof and the pulse starch is isolated or part of other materials, such as, but not limited to pulse flour.

3. The chewy confection of claim 1, wherein the chewy confection additionally comprises additional gelling agents selected from a group comprising corn starch, gelatin, agar, pectin, hydrocolloids, soybean protein, or combinations thereof.

4. The chewy confection of claim 1, wherein the chewy confection additionally comprises crystals of sugars or crystallizable sugar syrups selected from a group comprising sucrose, fructose, maltose, aldose, dextrose, glucose, or combinations thereof.

5. The chewy confection of claim 1, wherein the chewy confection additionally includes fiber material; wherein the fiber material is selected from a group comprising pulse flour, soybean flour, pulse starch concentrate, oat fiber material, fructooligosaccharide, inulin, chicory, or combinations thereof.

6. The chewy confection of claim 5, wherein the chewy confection further comprises protein material.

7. The chewy confection of claim 1, wherein the pulse starch is precooked, prejelled, instantized, or spray dried.

8. The chewy confection of claim 6, wherein the protein material is derived from a dairy source, meat source, or plant source.

9. The chewy confection of claim 10, wherein the protein material is sourced from a plant source.

10. The chewy confection of claim 6, wherein the chewy confection comprises starch, fiber, and protein from plant sources, preferably the plant source is pulses.

11. A method to make a chewy confection comprising: a) mixing pulse starch, sugar, water and acid to create a mixture; b) cooking the mixture until it reaches a temperature over 185 F; c) keeping the mixture heated at greater than 185 F for 0-15 minutes; d) adding optional ingredients, e) depositing mixture into starch molds, plastic molds, metal molds, pans, or onto cooling table; and f) allowing the mixture to cool to ambient temperature.

12. The method of claim 11, wherein the mixture is held at over 185 F until mixture reaches 75-85 Brix before adding remaining formula ingredients, depositing, and cooling.

13. The method of claim 12, wherein the mixture at over 185 F and at 75-90 Brix, is transferred to a high temperature cooker to cook to greater than 285 F, before adding remaining formula ingredients, depositing, and cooling.

14. The method of claim 13, wherein the mixture is held in the high temperature cooker at a temperature greater than 285 F until the mixture reaches 75-90 Brix, before adding remaining formula ingredients, depositing, and cooling.

15. The method of claim 14, wherein the acid is added to the mixture before the mixture reaches 185 F, is of a quantity to bring the mixture to a pH between 1 and 4, and any remaining formula acid is added to mixture before cooling.

16. The chewy confection of claim 1, wherein the chewy confection has a sample average hardness value of 2000 to 4000 grams force.

17. The method of claim 11, wherein fiber containing material, protein containing material, or combinations thereof are added to the mixture before first heating the mixture to over 185 F.

18. The method of claim 11, wherein fine grain sugar is blended into the mixture after cooking and before depositing.

19. The method of claim 11, wherein the mixture is pulled or whipped or high shear mixed after cooking and before depositing.

20. A method of making a chewy confection containing pulse starch, wherein the method comprises order of ingredient addition and temperature conditions (e.g., maximum temperature and duration of cook) chosen to create conditions necessary to create a strong gel without creating high viscosity greater than that which would be created by raw corn starch under similar conditions.
